(19) United States
(12) Patent Application Publication
(10) Pub. No.: US 2008/0208877 A1
(43) Pub. Date: Aug. 28, 2008

(54) METHOD FOR FILING ROADWAYS INCLUDED ON DIGITAL MAPS

(76) Inventors: Ulf Noyer, Braunschweig (DE); Nico Niehoff, Sickte (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/035,090

(22) Filed: Feb. 21, 2008

(30) Foreign Application Priority Data
Feb. 26, 2007 (DE) 10 2007 009 640.4

(51) Int. Cl. G06F 17/30

(52) U.S. Cl. 707/100; 707/E17.018

(57) ABSTRACT

The invention relates to a method for filing roadways which are included on digital maps and which comprise dotted lines formed by a multiplicity of measurement points, where the roadways are divided into a plurality of segments, a segment function is ascertained for each segment on the basis of the dotted line in the relevant segment, and the roadways are thus filed as the set of their segment functions.

### BACKGROUND OF THE INVENTION

1. Field of the Invention

The invention relates to a method for filing roadways which are included on digital maps and which comprise dotted lines formed by a multiplicity of measurement points.

2. Description of the Related Art

The roadways included on digital maps, such as roads or rails, normally comprise a multiplicity of measurement points which together form a dotted line and hence characterize the relevant roadway. To obtain such a dotted line, the relevant roadway must first of all be surveyed in advance using a suitable measuring apparatus. Normally, this is done by traveling along the relevant roadway, with the position being continually ascertained and stored during this time. From this multiplicity of measurement points, it is then possible to form a dotted line which represents the relevant roadway.

From these measurement points and dotted lines, it is then possible to file the roadways which are required for digital maps, for example. Such digital maps are known from navigation, for example. In this context, the road shape is approximated only very coarsely by straight lines, which results in inaccuracies which can be ignored when the maps are used for navigation, however. If highly accurate digital road maps are required, however, then the measurement points must likewise be highly accurate. In addition, the measurement points must succeed one another so closely that the interpolation from one measurement point to the next measurement point does not result in inaccuracies. Such highly accurate digital road maps are needed for the construction planning for railways or roadways, for example, but also for the rail planning for a (semi)autonomously moving vehicle. Particularly in the latter case, the map forms a fundamental basis for the control engineering problem.

A drawback in this context is that the multiplicity of measurement points required means that the volume of data per roadway is enormous, so that both the data management and the data transmission or remote data transmission have associated additional costs. The digital road maps used for navigation cannot be used in this case because their accuracy is not sufficient for the remit described above.

### SUMMARY OF THE INVENTION

It is therefore an object of the invention to specify an improved method which allows roadways on digital maps to be filed highly accurately and with a memory space saving.

The invention achieves the object by means of the method of the type cited at the outset by dividing the roadways into a plurality of segments, ascertaining a segment function for each segment on the basis of the dotted line in the relevant segment, and filing the roadways as a set of their segment functions.

The teaching of the present invention is accordingly based on the fact that the roadways to be digitized are first of all divided into a plurality of successive segments. For each segment, a function is now ascertained which is determined on the basis of the dotted line associated with each segment. In this context, the dotted line comprises a series of previously ascertained measurement points on the roadway, with the function to be ascertained advantageously approximating the dotted line in the segment. Once the relevant segment functions have been ascertained for all segments of the roadway, the roadway can be filed or stored as the set of its segment functions.

It is therefore possible for the roadway not to be filed as the set of its measurement points, as previously, but rather for the roadway now to be described by a series of functions. This allows the volume of data per roadway to be significantly reduced, since it is no longer necessary to file each measurement point individually.

In this context, the roadways are usually segmented such that the endpoint of the preceding segment forms the starting point of the subsequent segment. Alternatively, it is conceivable for the segments to overlap.

Advantageously, the dotted lines in the segments are approximated by splines, clothoids or Bézier curves. Particularly clothoids are especially well suited in this context, since they are frequently used for planning road shapes. Clothoids are functions which are described by a starting curvature and a change in curvature. This allows particularly harmonic transitions between straight lines and curve shapes for which no abrupt changes of direction arise in road and rail construction. To keep the required memory capacity as low as possible, advantageously only the parameters of the individual segment functions are stored. It is thus conceivable for the method to be restricted to a particular type of segment function and for only the parameterization of the individual segment functions to be stored, instead of filing the respective relevant function for each segment.

It is also advantageous if, when the roadways are divided into segments, the length of the segments is chosen such that it is at a maximum. In other words, that is to say that, in order to keep down the volume of data as far as possible, the roadways are divided into segments such that the number of segments per roadway is as small as possible. However, a segment must not be chosen to be too long, since otherwise the function associated with the segment no longer approximates the dotted line with sufficient accuracy.

It is therefore particularly advantageous if the length of the segments is chosen on the basis of a power function, so that it is possible to ensure that the segment functions describe the dotted lines in the segments with sufficient accuracy. The power function can accordingly identify, as a quality function, whether the segment function describes the segment with sufficient accuracy or whether the relevant segment has been chosen to be too long. It is thus conceivable, by way of example, for the power function to ascertain the discrepancy between the dotted line in the segment and the curve shape of the segment function, this discrepancy being able to be taken as a basis for altering the length of the segment.

It thus quite particularly advantageous if the length of the segment is not changed until the discrepancy in the power function has exceeded a particular threshold value. Alternatively, it is conceivable for the value of the discrepancy to be used as a quantitative measure of the change in the length. That is to say that, the greater the discrepancy, the greater the extent to which the segment is shortened. In this context, the discrepancy considered may be, by way of example, the interval between the dotted line and the curve shape, or else the discrepancy in the course angle. It is thus conceivable, by way of example, for an excessive discrepancy in the course angle to prompt the segment to be shortened accordingly.

In addition, it is particularly advantageous if the roadways are divided into segments such that the length of the segments is chosen on the basis of meta information or meta data for the roadways and/or the segments. Such meta information or meta data is/are basic information about the type and characteristic of the roadways and, by way of example, may be the number of lanes on a roadway, the width of the lanes, the lane markers or approach and exit roads. It is thus conceivable, by way of example, for a new segment to be started when the meta data or meta information change(s). Thus, a new segment can be started at the precise time at which the lane marker changes from a solid line to a dashed line.

To obtain an adequate approximation of the segment function, it is particularly advantageous if the length of the segment is shortened in steps. To this end, each step involves the segment function being ascertained and a check being performed to determine how accurate the ascertained segment function is relative to the dotted line in the segment. If sufficient accuracy of the segment function has been established, the relevant segment does not need to be shortened further. Otherwise, a further iteration step needs to be performed.

It is also particularly advantageous if the roadways ascertained by this method are filed on a digital storage medium.

### BRIEF DESCRIPTION OF THE DRAWINGS

The present invention is explained in more detail by way of example with reference to the appended drawing, in which:

FIGS. 1a and 1b-show an illustration of the step-by-step shortening of a segment until there is an acceptable approximation by the segment function;

FIG. 2—shows an illustration of a roadway approximated by a plurality of segment functions.

### DETAILED DESCRIPTION OF THE PREFERRED EMBODIMENT

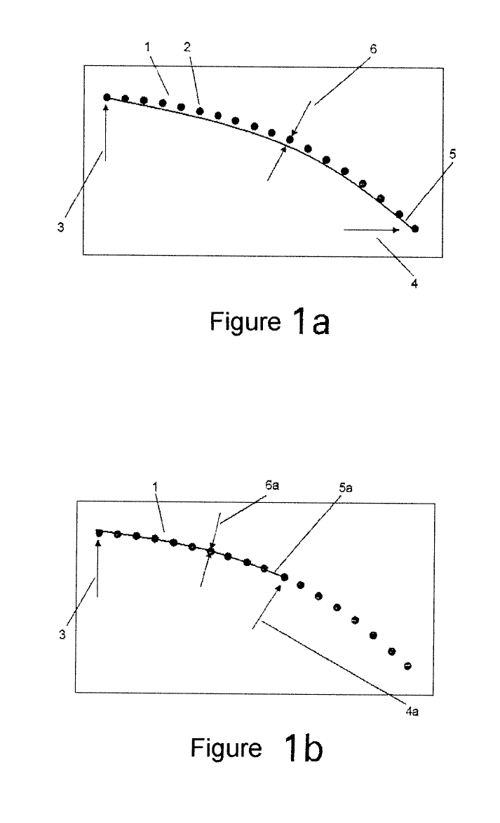

FIG. 1a shows the result following a first segmentation step. In this case, the relevant segment comprises a dotted line 1, comprising a plurality of measurement points 2. The segment is formed by a start 3 and an end 4, with a segment function having been ascertained in-between whose curve shape 5 approximates the dotted line 1.

A subsequent step is used to ascertain whether the curve shape 5 of the segment function approximates the dotted line 1 with sufficient accuracy. To this end, the interval 6 between the dotted line 1 and the curve shape 5 of the segment function is determined and a check is performed to determine whether this interval exceeds the previously defined threshold value. The interval 6 is thus a qualitative measure of the approximation.

If it is established that the curve shape 5 of the segment function does not approximate the dotted line 1 with sufficient accuracy, the relevant segment needs to be shortened. This is shown schematically in FIG. 1b. Between the segment start 3 and the freshly chosen segment end 4a, a segment function is now again ascertained whose curve shape 5a approximates the relevant dotted line 1 accordingly. The interval 6a between the dotted line and the approximated segment function is likewise ascertained again in order to establish how accurately the segment function approximates the dotted line 1. In the exemplary embodiment shown in FIG. 1b, it can be seen that the curved shape 5a of the segment function approximates the dotted line in the segment between the start 3 and the end 4a with sufficient accuracy, which means that it is possible to dispense with further shortening of the segment. In this case, the segment end 4a would form a new start 3 for a subsequent segment and the segmentation method would be performed with the next segment. This allows a surveyed roadway to be described by a series of segment functions with sufficient accuracy without the need to store every single measurement point.

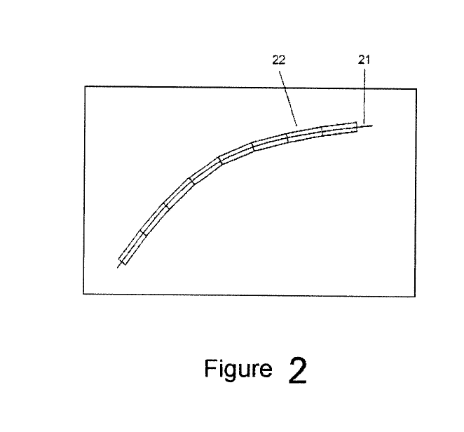

FIG. 2 schematically shows the result of such a segmentation method for a roadway. As can be seen the roadway 21 is divided into a series of segments 22. For each segment 22, there exists a segment function which approximates the roadway in the segment area with sufficient accuracy. The roadway 21 can thus be described as the set of its segment functions for the individual segments 22. In this case, the segments 22 of the roadway 21 have been shortened in steps until the check by a power function has established that the approximation of the segment function to the roadway is sufficiently accurate for the remit of interest.

1. Method for filing roadways which are included on digital maps and which comprise dotted lines formed by a multiplicity of measurement points, characterized by the roadways being divided into a plurality of segments, a segment function being ascertained for each segment on the basis of the dotted line in the relevant segment, and the roadways being filed as the set of their segment functions.

2. Method according to claim 1, characterized by the segment function being ascertained as a function which approximates the dotted line in the relevant segment.

3. Method according to claim 1, characterized by clothoids, splines or Bézier curves as segment functions.

4. Method according to claim 1, characterized by the parameters of the segment functions being filed.

5. Method according to claim 1, characterized by the roadways being divided into segments such that the length of at least one segment is maximized.

6. Method according to claim 1, characterized by the roadways being divided into segments such that the length of at least one segment is chosen on the basis of meta data relating to the roadway or the segment.

7. Method according to claim 1, characterized by the roadways being divided into segments such that the length of at least one segment is chosen on the basis of a power function.

8. Method according to claim 7, characterized in that the power function determines a discrepancy between the dotted line in a segment and the shape of the associated segment function, the length of at least one segment being chosen on the basis of the relevant discrepancy.

9. Method according to claim 8, characterized in that the length of at least one segment is chosen such that the discrepancy does not exceed a definable threshold value.

10. Method according to claim 8, characterized in that the discrepancy considered is the interval and/or the course angle.

11. Method according to claim 1, characterized in that a segment is shortened in steps until there is an adequate approximation by the segment function.

12. Method according to claim 1, characterized by the roadways being filed on a digital storage medium.
